(19) United States
(12) Patent Application Publication
(10) Pub. No.: US 2026/0155547 A1
(43) Pub. Date: Jun. 4, 2026

(54) VEHICLE POWER SOURCE APPARATUS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takahiro OKAMOTO, Osaka (JP); Hiroki SHIMODA, Osaka (JP); Taiji YANAGIDA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 19/134,789

(22) PCT Filed: Nov. 22, 2023
(86) PCT No.: PCT/JP2023/041974

§ 371 Date: Jun. 2, 2025

(30) Foreign Application Priority Data
Dec. 13, 2022 (JP) 2022-198518

(51) Int. Cl. B60L 3/00; B60R 16/03

(52) U.S. Cl. CPC H01M 50/583; B60L 3/0046; H01M 10/44; H01M 50/581; H01M 2220/20

(57) ABSTRACT

A vehicle power source apparatus includes a first positive-side relay, a second positive-side relay, and a positive-side switch unit. The first positive-side relay is provided on a first positive-side branch path between a battery and a first power-supplied object. The second positive-side relay is provided on a second positive-side branch path between the battery and a second power-supplied object. The positive-side switch unit is provided between a first positive-side conductive path, which is a part of the first positive-side branch path that is closer to the first power-supplied object than the first positive-side relay, and a second positive-side conductive path, which is a part of the second positive-side branch path that is closer to the second power-supplied object than the second positive-side relay.

### TECHNICAL FIELD

The present disclosure relates to a vehicle power source apparatus.

### BACKGROUND ART

Patent Document 1 discloses a power supplying apparatus that uses an electric vehicle. This power supplying apparatus includes a drive battery. The drive battery is connected via a high-voltage line to an MCU inverter, and is connected via a rapid charging high voltage line to a V2X device. In other words, the drive battery in Patent Document 1 is connected via a first line to a first power-supplied object and is connected via a second line to a second power-supplied object.

### CITATION LIST

### Patent Documents

Patent Document 1: JP 2014-103707A

### SUMMARY OF INVENTION

### Technical Problem

For technologies of this type, when the first line is cut off, it is no longer possible to supply power to the first power-supplied object, and when the second line is cut off, it is no longer possible to supply power to the second power-supplied object.

It is an object of the present disclosure to provide a technology that makes the supplying of power from a battery to a power-supplied object less susceptible to being interrupted.

### Solution to Problem

A vehicle power source apparatus according to an aspect of the present disclosure is a vehicle power source apparatus for use in a vehicle power source system including: a battery; a positive side common path connected to a positive terminal of the battery, a first positive-side branch path that branches from the positive-side common path; a first power-supplied object connected to the first positive-side branch path; a second positive side branch path that branches from the positive side common path; and a second power-supplied object connected to the second positive side branch path, the vehicle power source apparatus including: a first positive side relay provided on the first positive side branch path between the battery and the first power-supplied object; a second positive-side relay provided on the second positive side branch path between the battery and the second power-supplied object; and a positive-side switch unit provided between a first positive side conductive path, which is a part of the first positive-side branch path that is closer to the first power-supplied object than the first positive-side relay, and a second positive side conductive path, which is a part of the second positive-side branch path that is closer to the second power-supplied object than the second positive side relay.

### Advantageous Effects of Invention

The technology according to the present disclosure makes the supplying of power from a battery to a power-supplied object less susceptible to interruption.

### BRIEF DESCRIPTION OF DRAWINGS

FIG. 1 is a circuit diagram schematically depicting a vehicle power source system equipped with a vehicle power source apparatus according to a first embodiment.

FIG. 2 is a diagram useful in explaining an operation when the vehicle power source apparatus has executed first control, for a case where a relay to be switched is a first positive side relay.

FIG. 3 is a diagram useful in explaining an operation when the vehicle power source apparatus has executed first control, for a case where a relay to be switched is a second positive-side relay.

FIG. 4 is a diagram useful in explaining an operation when the vehicle power source apparatus has executed first control, for a case where a relay to be switched is a first negative-side relay.

FIG. 5 is a diagram useful in explaining an operation when the vehicle power source apparatus has executed first control, for a case where a relay to be switched is a second negative-side relay.

FIG. 6 is a circuit diagram schematically depicting a vehicle power source system equipped with a vehicle power source apparatus according to a second embodiment.

### DESCRIPTION OF EMBODIMENTS OF THE PRESENT DISCLOSURE

Several embodiments of the present disclosure are listed and described in outline below.
(1) A vehicle power source apparatus according to an aspect of the present disclosure is a vehicle power source apparatus for use in a vehicle power source system including: a battery; a positive-side common path connected to a positive terminal of the battery; a first positive-side branch path that branches from the positive-side common path; a first power-supplied object connected to the first positive-side branch path; a second positive side branch path that branches from the positive side common path; and a second power-supplied object connected to the second positive side branch path, the vehicle power source apparatus including: a first positive side relay provided on the first positive side branch path between the battery and the first power supplied object; a second positive-side relay provided on the second positive-side branch path between the battery and the second power-supplied object; and a positive side switch unit provided between a first positive-side conductive path, which is a part of the first positive-side branch path that is closer to the first power-supplied object than the first positive-side relay, and a second positive side conductive path, which is a part of the second positive-side branch path that is closer to the second power-supplied object than the second positive-side relay.

The vehicle power source apparatus can supply battery-based power to the first power-supplied object via the positive-side common path and the first positive-side branch path and can supply the power to the second power-supplied object via the positive side common path and the second positive-side branch path. Even if the first positive-side branch path is cut off closer to the battery than the positive-side switch unit, by switching the positive-side switch unit to the on state, the vehicle power source apparatus can still supply power to the first power-supplied object via the second positive side branch path. Even if the second positive-side branch path is cut off closer to the battery than the positive-side switch unit, by switching the positive-side switch unit to the on state, the vehicle power source apparatus can still supply power to the second power supplied object via the first positive side branch path. In other words, the vehicle power source apparatus described above is less susceptible to interruptions to the supplying of power from the battery to the first power-supplied object and the second power-supplied object.
(2) For the vehicle power source apparatus according to (1) above, the vehicle power source system further includes a first capacitor that is connected to the first positive-side conductive path and a second capacitor that is connected to the second positive side conductive path, and the vehicle power source apparatus further includes a circuit unit configured to perform a precharge operation that supplies power to at least one of the first capacitor and the second capacitor with the first positive side relay and the second positive side relay in an off state.

Before switching the first positive side relay or the second positive-side relay to the on state, the vehicle power source apparatus described above can perform a precharge operation using the circuit unit to charge at least one of the first capacitor and the second capacitor. By taking this countermeasure, the vehicle power source apparatus can suppress the inrush current that flows through whichever of the first positive side relay and the second positive-side relay is switched to the on state, and in turn suppress deterioration of the relays.
(3) For the vehicle power source apparatus according to (2) above, the vehicle power source system further includes a negative-side common path connected to a negative terminal of the battery, a first negative side branch path that branches from the negative-side common path and is connected to the first power-supplied object, and a second negative side branch path that branches from the negative side common path and is connected to the second power-supplied object, the vehicle power source apparatus further includes: a negative-side switch unit provided between the first negative-side branch path and the second negative-side branch path; a first negative-side relay provided on the first negative-side branch path between the battery and the negative-side switch unit; a second negative-side relay provided on the second negative side branch path between the battery and the negative side switch unit; and a parallel circuit constructed of a resistance unit and a parallel relay that are connected in series, and the parallel circuit is provided in parallel with each of the first negative-side relay and the second negative-side relay.

Although switching the first positive-side relay or the second positive-side relay to the on state after the precharge operation does suppress deterioration of the relays, some deterioration may still occur. The vehicle power source apparatus described above can perform the precharge operation that charges the first capacitor and the second capacitor when a parallel relay, the positive-side switch unit, and the negative side switch unit are in the on state and the first positive-side relay or the second positive-side relay is in the on state. After this precharge operation, the vehicle power source apparatus performs a countermeasure of switching the first negative-side relay or the second negative-side relay, which is provided in parallel with the parallel relay mentioned above, to the on state, which makes it possible to supply power from the battery to the first power-supplied object and the second power-supplied object without passing the resistance unit. By performing this operation, deterioration of the first positive-side relay and the second positive side relay can be suppressed more effectively.
(4) For the vehicle power source apparatus according to (3) above, the circuit unit includes the parallel circuits provided in parallel with the first positive-side relay and the second positive-side relay respectively, the vehicle power source apparatus includes a control unit configured to control the first positive-side relay, the second positive side relay, the first negative-side relay, the second negative-side relay, and the parallel relays, and the control unit executes, when a start condition for starting charging and discharging of the battery is satisfied, first control to control switching of the parallel relay of the parallel circuit provided in parallel with a relay to be switched out of the first positive-side relay, the second positive-side relay, the first negative-side relay, and the second negative-side relay to an on state, and executes, when a switching condition is satisfied during execution of the first control, second control to switch the relay to be switched to an on state.

By executing the first control, the vehicle power source apparatus described above can cause a parallel circuit provided in parallel with the relay to be switched to perform a precharge operation. By executing the second control, the vehicle power source apparatus then switches the relay to be switched to the on state. In other words, the vehicle power source apparatus can select the relay to be switched to the on state after the precharge operation from four relays, namely the first positive side relay, the second positive side relay, the first negative side relay, and the second negative-side relay.
(5) For the vehicle power source apparatus according to (4) above, the control unit compares deterioration levels of the first positive-side relay, the second positive-side relay, the first negative-side relay, and the second negative side relay, and selects the relay to be switched based on a comparison result.

The vehicle power source apparatus described above can reflect the deterioration levels of the relays in the selection of the relay to be switched.
(6) For the vehicle power source apparatus according to (5) above, the control unit selects the relay with the lowest deterioration level as the relay to be switched.

The vehicle power source apparatus described above promotes uniform deterioration of the relays, which makes it easy to extend the life of an apparatus including relays.
(7) For the vehicle power source apparatus according to any one of (3) to (6) above, the parallel circuit provided in parallel with the first negative-side relay has a configuration where a negative side resistance unit as the resistance unit and a first negative-side parallel relay as the parallel relay are connected in series, and the parallel circuit provided in parallel with the second negative-side relay has a configuration where the negative-side resistance unit and a second negative-side parallel relay as the parallel relay are connected in series.

The vehicle power source apparatus described above can make shared use of the negative side resistance unit in the parallel circuit disposed in parallel with the first negative side relay and the parallel circuit disposed in parallel with the second negative side relay.
(8) For the vehicle power source apparatus according to any one of (1) to (7) above, the vehicle power source system further includes a negative-side common path connected to a negative terminal of the battery, a first negative-side branch path that branches from the negative-side common path and is connected to the first power-supplied object, and a second negative side branch path that branches from the negative side common path and is connected to the second power-supplied object, and the vehicle power source apparatus further includes a negative-side switch unit provided between the first negative side branch path and the second negative side branch path.

Even if the first negative side branch path is cut off at a position closer to the battery than the negative side switch unit, by switching the negative side switch unit to the on state, the vehicle power source apparatus can electrically connect the first power-supplied object to the negative terminal of the battery via the second negative side branch path. Similarly, even if the second negative side branch path is cut off at a position closer to the battery than the negative-side switch unit, by switching the negative side switch unit to the on state, the vehicle power source apparatus can electrically connect the second power-supplied object to the negative terminal of the battery via the first negative-side branch path. In other words, in the vehicle power source apparatus described above, the supplying of power from the battery to the power-supplied objects is less susceptible to being interrupted.
(9) The vehicle power source apparatus according to (8) above, further including a thermal fuse that melts when a melting temperature is exceeded, wherein the thermal fuse is provided on at least one of: part of the first positive-side branch path that is closer to the battery than the positive side switch unit; part of the second positive side branch path that is closer to the battery than the positive-side switch unit; part of the first negative side branch path that is closer to the battery than the negative-side switch unit, and part of the second negative-side branch path that is closer to the battery than the negative side switch unit.

In the vehicle power source apparatus described above, when the thermal fuse exceeds the melting temperature, the thermal fuse will melt and cut off the path where it is provided. Even when a path has been cut off, the vehicle power source apparatus can still continue supplying power to the first power-supplied object or the second power-supplied object by bypassing the melted path.
(10) The vehicle power source apparatus according to (2) above, further includes a control unit configured to control the first positive-side relay, the second positive-side relay, and the circuit unit, wherein when a start condition for starting charging and discharging of the battery is satisfied, the control unit causes the circuit unit to perform the precharge operation, and then executes control to switch a relay to be switched out of the first positive side relay and the second positive-side relay to an on state, and the control unit compares deterioration levels of the first positive-side relay and the second positive-side relay and selects the relay to be switched based on a comparison result.

The vehicle power source apparatus described above can reflect the deterioration levels of the relays in the selection of the relay to be switched.

### First Embodiment

### 1. Configuration of Vehicle Power Source System 100

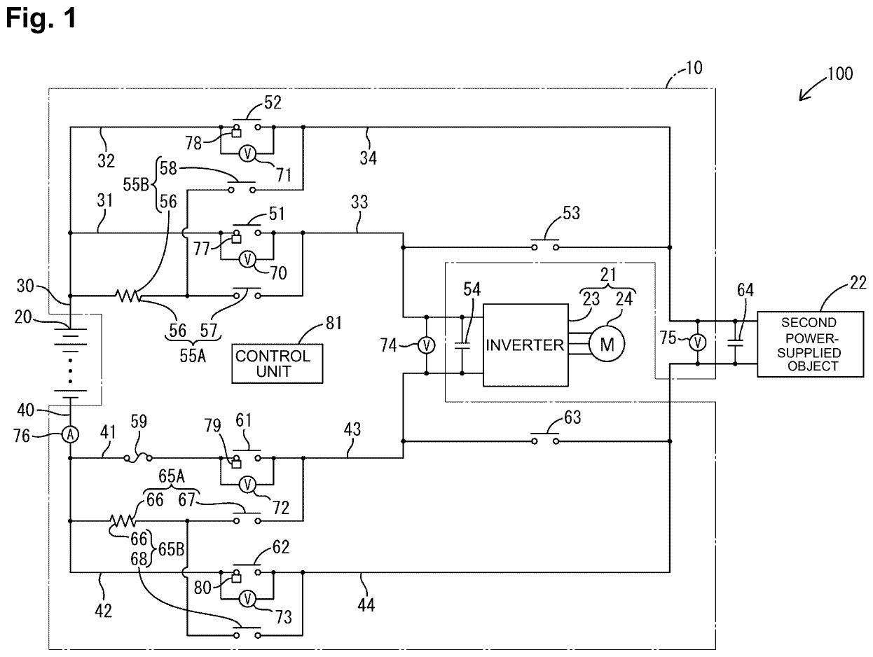

FIG. 1 depicts a vehicle power source system 100 equipped with a vehicle power source apparatus 10. The vehicle power source system 100 is used in a vehicle (not illustrated). Such vehicle may be an electric vehicle, an engine-powered vehicle, or a hybrid vehicle. In addition to the vehicle power source apparatus 10, the vehicle power source system 100 includes a battery 20, a first power-supplied object 21, and a second power-supplied object 22.

The battery 20 may be a lithium ion battery, a lead acid battery, or another type of battery. The negative terminal of the battery 20 is electrically connected to ground. In the present specification, unless specified otherwise, the expression “voltage” refers to voltages with respect to ground potential.

The first power-supplied object 21 is supplied with power from the battery 20. As one example the first power-supplied object 21 is a vehicle-mounted electrical device. In the present embodiment, the first power-supplied object 21 is constructed as a driving unit that drives the wheels of the vehicle. The first power-supplied object 21 includes an inverter 23 and a motor 24. The inverter 23 generates an AC voltage (for example, three-phase AC) from a DC voltage based on a voltage supplied from the battery 20 to the motor 24. The motor 24 is a main machine motor, for example. The motor 24 is an apparatus that rotates based on the electrical power supplied from the battery 20 and applies a rotational force to the wheels of the vehicle.

The second power-supplied object 22 is supplied with power based on the battery 20. The second power supplied object 22 is an electrical device. As one example, the second power-supplied object 22 may be an electric device that uses Vehicle to Everything (V2X) communication. The second power supplied object 22 may be a vehicle-mounted electrical device or may be an external electrical device. As specific examples, the second power-supplied object 22 may be a vehicle-mounted charger (for example, an on-board charger) or an external charger (for example, an off-board charger). When the second power-supplied object 22 is a vehicle-mounted electrical device, the entire vehicle power source system 100 is mounted on the vehicle. When the second power supplied object 22 is an external electrical device, the components of the vehicle power source system 100 aside from the second power-supplied object 22 are mounted on the vehicle.

The vehicle power source system 100 includes a positive side common path 30, a first positive-side branch path 31, a second positive-side branch path 32, a negative-side common path 40, a first negative-side branch path 41, and a second negative-side branch path 42.

The positive-side common path 30 is electrically connected to the positive terminal of the battery 20. The first positive-side branch path 31 and the second positive side branch path 32 each branch off from the positive side common path 30. The negative-side common path 40 is electrically connected to the negative terminal of the battery 20. The first negative side branch path 41 and the second negative-side branch path 42 each branch off from the negative-side common path 40. The first positive-side branch path 31 and the first negative side branch path 41 are electrically connected to the first power-supplied object 21. The second positive-side branch path 32 and the second negative-side branch path 42 are electrically connected to the second power-supplied object 22.

The first positive-side branch path 31 includes a first positive-side conductive path 33, which is a part of the first positive-side branch path 31 that is closer to the first power-supplied object 21 than a first positive side relay 51, described later. The second positive-side branch path 32 includes a second positive-side conductive path 34, which is a part of the second positive-side branch path 32 that is closer to the second power-supplied object 22 than a second positive side relay 52, described later. The first negative-side branch path 41 includes a first negative-side conductive path 43, which is a part of the first negative-side branch path 41 that is closer to the first power-supplied object 21 than a first negative side relay 61, described later. The second negative-side branch path 42 includes a second negative-side conductive path 44, which is a part of the second negative-side branch path 42 that is closer to the second power-supplied object 22 than a second negative-side relay 62, described later.

The vehicle power source system 100 includes a first capacitor 54 and a second capacitor 64.

The first capacitor 54 is provided between the first positive side branch path 31 (In more detail, the first positive side conductive path 33) and the first negative-side branch path 41 (in more detail, the first negative-side conductive path 43). A first end of the first capacitor 54 is electrically connected to the first positive-side branch path 31 (in more detail, to the first positive side conductive path 33). The other end of the first capacitor 54 is electrically connected to the first negative-side branch path 41 (in more detail, to the first negative-side conductive path 43). The first capacitor 54 is provided between the battery 20 and the first power-supplied object 21. The first capacitor 54 functions as a smoothing capacitor that smoothes the voltage applied to the first positive side branch path 31 (in more detail, the first positive-side conductive path 33).

The second capacitor 64 is provided between the second positive-side branch path 32 (in more detail, the second positive-side conductive path 34) and the second negative-side branch path 42 (in more detail, the second negative side conductive path 44). A first end of the second capacitor 64 is electrically connected to the second positive-side branch path 32 (in more detail, to the second positive-side conductive path 34). The other end of the second capacitor 64 is electrically connected to the second negative-side branch path 42 (in more detail, to the second negative-side conductive path 44). The second capacitor 64 is provided between the battery 20 and the second power-supplied object 22. The second capacitor 64 functions as a smoothing capacitor that smoothes the voltage applied to the second positive-side branch path 32 (in more detail, the second positive-side conductive path 34).

### 2. Configuration of Vehicle Power Source Apparatus 10

The vehicle power source apparatus 10 is used in the vehicle power source system 100. The vehicle power source apparatus 10 supplies power, which has been supplied from the battery 20, to the first power-supplied object 21 and the second power-supplied object 22.

The vehicle power source apparatus 10 includes a first positive side relay 51, a second positive-side relay 52, a first negative side relay 61, and a second negative-side relay 62. The first positive-side relay 51, the second positive side relay 52, the first negative-side relay 61, and the second negative side relay 62 each include a mechanical switch with contacts.

The first positive side relay 51 is provided on the first positive-side branch path 31 between the battery 20 and the first power-supplied object 21. A first end of the first positive-side relay 51 is electrically connected to the positive terminal of the battery 20 in a configuration where the first positive-side relay 51 is short-circuited to the positive terminal of the battery 20. The other end of the first positive-side relay 51 is electrically connected to a first end of the first capacitor 54 and to a first end of the first power-supplied object 21 in a configuration where the first positive side relay 51 is short-circuited to the first end of the first capacitor 54 and the first end of the first power-supplied object 21. When the first positive-side relay 51 is in the on state, the first positive-side relay 51 electrically connects the positive terminal of the battery 20 to the first end of the first capacitor 54 and to the first end of the first power-supplied object 21. When the first positive-side relay 51 is in the off state, the electrical connection between the positive terminal of the battery 20 and the first end of the first capacitor 54 and the first end of the first power-supplied object 21 via the first positive-side relay 51 is cut off.

The second positive side relay 52 is provided on the second positive-side branch path 32 between the battery 20 and the second power-supplied object 22. A first end of the second positive-side relay 52 is electrically connected to the positive terminal of the battery 20 in a configuration where the second positive side relay 52 is short-circuited to the positive terminal of the battery 20. The other end of the second positive side relay 52 is electrically connected to a first end of the second capacitor 64 and to a first end of the second power-supplied object 22 in a configuration where the second positive side relay 52 is short-circuited to the first end of the second capacitor 64 and the first end of the second power-supplied object 22. When the second positive-side relay 52 is in the on state, the second positive-side relay 52 electrically connects the positive terminal of the battery 20 to the first end of the second capacitor 64 and to the first end of the second power-supplied object 22. When the second positive-side relay 52 is in the off state, the electrical connection between the positive terminal of the battery 20 to the first end of the second capacitor 64 and the first end of the second power-supplied object 22 via the second positive-side relay 52 is cut off.

The first negative-side relay 61 is provided on the first negative-side branch path 41 between the battery 20 and the first power-supplied object 21. A first end of the first negative side relay 61 is electrically connected to the negative-side conductive terminal of the battery 20 in a configuration where the first negative-side relay 61 is short-circuited to the negative terminal of the battery 20. The other end of the first negative-side relay 61 is electrically connected to the other end of the first capacitor 54 and the other end of the first power-supplied object 21 in a configuration where the first negative-side relay 61 is short-circuited to other end of the first capacitor 54 and other end of the first power-supplied object 21. When the first negative-side relay 61 is in the on state, the first negative-side relay 61 electrically connects the negative terminal of the battery 20 to the other end of the first capacitor 54 and to the other end of the first power-supplied object 21. When the first negative-side relay 61 is in the off state, the electrical connection between the negative terminal of the battery 20 and the other end of the first capacitor 54 and the other end of the first power-supplied object 21 via the first negative-side relay 61 is cut off.

The second negative-side relay 62 is provided on the second negative-side branch path 42 between the battery 20 and the second power-supplied object 22. A first end of the second negative-side relay 62 is electrically connected to the negative terminal of the battery 20 in a configuration where the second negative-side relay 62 is short-circuited to the negative terminal of the battery 20. The other end of the second negative-side relay 62 is electrically connected to the other end of the second capacitor 64 and to the other end of the second power supplied object 22 in a configuration where the second negative side relay 62 is short-circuited to the other end of the second capacitor 64 and the other end of the second power-supplied object 22. When the second negative-side relay 62 is in the on state, the second negative-side relay 62 electrically connects the negative terminal of the battery 20 to the other end of the second capacitor 64 and to the other end of the second power-supplied object 22. When the second negative-side relay 62 is in the off state, the electrical connection between the negative terminal of the battery 20 and the other end of the second capacitor 64 and the other end of the second power-supplied object 22 via the second negative-side relay 62 is cut off.

The vehicle power source apparatus 10 includes a positive-side switch unit 53 and a negative side switch unit 63. The positive-side switch unit 53 and the negative-side switch unit 63 may include a mechanical switch with contacts, or may include a semiconductor switching element, such as a field effect transistor (FET).

The positive-side switch unit 53 is provided between the first positive side conductive path 33 and the second positive-side conductive path 34. A first end of the positive side switch unit 53 is electrically connected to the first positive-side conductive path 33 in a configuration where the positive-side switch unit 53 is short-circuited to the first positive-side conductive path 33. This first end of the positive-side switch unit 53 is electrically connected to the other end of the first positive-side relay 51, the first end of the first capacitor 54, and the first end of the first power-supplied object 21 in a configuration where the positive-side switch unit 53 is short-circuited to the other end of the first positive-side relay 51, the first end of the first capacitor 54, and the first end of the first power-supplied object 21. The other end of the positive-side switch unit 53 is electrically connected to the second positive-side conductive path 34 in a configuration where the positive-side switch unit 53 is short-circuited to the second positive-side conductive path 34. The other end of the positive-side switch unit 53 is electrically connected to the other end of the second positive side relay 52, the first end of the second capacitor 64, and the first end of the second power supplied object 22 in a configuration where the positive-side switch unit 53 is short-circuited to the other end of the second positive side relay 52, the first end of the second capacitor 64, and the first end of the second power-supplied object 22. When the positive-side switch unit 53 is in the on state, the first positive side conductive path 33 and the second positive side conductive path 34 are electrically connected in a configuration where the first positive-side conductive path 33 and the second positive-side conductive path 34 are short-circuited. When the positive-side switch unit 53 is in the off state, the flow of current in both directions via the positive side switch unit 53 is cut off.

The negative-side switch unit 63 is provided between the first negative-side conductive path 43 and the second negative-side conductive path 44. A first end of the negative side switch unit 63 is electrically connected to the first negative-side conductive path 43 in a configuration where the negative side switch unit 63 is short-circuited to the first negative-side conductive path 43. This first end of the negative-side switch unit 63 is electrically connected to the other end of the first negative-side relay 61, the other end of the first capacitor 54, and the other end of the first power supplied object 21 in a configuration where the negative-side switch unit 63 is short-circuited to the other end of the first negative-side relay 61, the other end of the first capacitor 54, and the other end of the first power-supplied object 21. The other end of the negative-side switch unit 63 is electrically connected to the second negative-side conductive path 44 in a configuration where the negative-side switch unit 63 is short-circuited to the second negative-side conductive path 44. Such other end of the negative-side switch unit 63 is electrically connected to the other end of the second negative-side relay 62, the other end of the second capacitor 64, and the other end of the second power-supplied object 22 in a configuration where the negative-side switch unit 63 is short-circuited to the other end of the second negative-side relay 62, the other end of the second capacitor 64, and the other end of the second power-supplied object 22. When the negative-side switch unit 63 is in an on state, the first negative side conductive path 43 and the second negative-side conductive path 44 are electrically connected in a configuration where the first negative side conductive path 43 and the second negative-side conductive path 44 are short circuited. When the negative-side switch unit 63 is in an off state, the flow of current in both directions via the negative-side switch unit 63 is cut off.

The vehicle power source apparatus 10 includes positive-side parallel circuits 55A and 55B. The positive-side parallel circuits 55A and 55B correspond to examples of “parallel circuits” for the present disclosure and also correspond to “circuit units” for the present disclosure. The positive-side parallel circuits 55A and 55B perform a precharge operation to supply power to at least one of the first capacitor 54 and the second capacitor 64 in a state where the first positive-side relay 51 and the second positive-side relay 52 are in the off state.

The positive-side parallel circuit 55A is provided in parallel with the first positive-side relay 51. The positive side parallel circuit 55A is constructed by connecting a positive side resistance unit 56 and a first positive-side parallel relay 57 in series. A first end of the positive side parallel circuit 55A is electrically connected to a path between the first end of the first positive-side relay 51 and the positive terminal of the battery 20 in a configuration where the positive side parallel circuit 55A is short-circuited to the path between the first end of the first positive-side relay 51 and the positive terminal of the battery 20. The first end of the positive-side parallel circuit 55A is electrically connected to the positive terminal of the battery 20, the first end of the first positive-side relay 51, and the first end of the second positive side relay 52 in a configuration where the positive-side parallel circuit 55A is short-circuited to the positive terminal of the battery 20, the first end of the first positive-side relay 51, and the first end of the second positive-side relay 52. The other end of the positive-side parallel circuit 55A is electrically connected to the first positive side conductive path 33 in a configuration where the positive-side parallel circuit 55A is short-circuited to the first positive-side conductive path 33. The other end of the positive-side parallel circuit 55A is electrically connected to the other end of the first positive-side relay 51, the first end of the first capacitor 54, the first end of the first power-supplied object 21, and the first end of the positive-side switch unit 53 in a configuration where the positive side parallel circuit 55A is short-circuited to the other end of the first positive-side relay 51, the first end of the first capacitor 54, the first end of the first power-supplied object 21, and the first end of the positive-side switch unit 53.

The positive-side parallel circuit 55B is provided in parallel with the second positive-side relay 52. The positive-side parallel circuit 55B is constructed by connecting a positive-side resistance unit 56 and a second positive-side parallel relay 58 in series. A first end of the positive-side parallel circuit 55B is electrically connected to a path between the first end of the second positive-side relay 52 and the positive terminal of the battery 20 in a configuration where the positive-side parallel circuit 55B is short-circuited to the path between the first end of the second positive-side relay 52 and the positive terminal of the battery 20. The first end of the positive side parallel circuit 55B is electrically connected to the positive terminal of the battery 20, a first end of the first positive side relay 51, and a first end of the second positive-side relay 52 in a configuration where the positive side parallel circuit 55B is short-circuited to the positive terminal of the battery 20, the first end of the first positive-side relay 51, and the first end of the second positive-side relay 52. The other end of the positive-side parallel circuit 55B is electrically connected to the second positive side conductive path 34 in a configuration where the positive-side parallel circuit 55B is short-circuited to the second positive-side conductive path 34. The other end of the positive side parallel circuit 55B is electrically connected to the other end of the second positive-side relay 52, the first end of the second capacitor 64, the first end of the first power-supplied object 21, and the other end of the positive side switch unit 53 in a configuration where the positive side parallel circuit 55B is short-circuited to the other end of the second positive-side relay 52, the first end of the second capacitor 64, the first end of the first power-supplied object 21, and the other end of the positive-side switch unit 53.

A first end of the positive side resistance unit 56 is electrically connected to the path between the first end of the first positive-side relay 51 and first end of the second positive-side relay 52 and the positive terminal of the battery 20 in a configuration where the positive-side resistance unit 56 is short-circuited to the path between the first end of the first positive-side relay 51 and first end of the second positive-side relay 52 and the positive terminal of the battery 20. The other end of the positive-side resistance unit 56 is electrically connected to a first end of the first positive-side parallel relay 57 and a first end of the second positive side parallel relay 58 in a configuration where the positive-side resistance unit 56 is short-circuited to the first end of the first positive-side parallel relay 57 and the first end of the second positive side parallel relay 58.

The other end of the first positive side parallel relay 57 is electrically connected to the first positive side conductive path 33 in a configuration where the first positive-side parallel relay 57 is short-circuited to the first positive-side conductive path 33. The other end of the first positive side parallel relay 57 is electrically connected to the other end of the first positive-side relay 51, the first end of the first capacitor 54, the first end of the first power-supplied object 21, and the first end of the positive side switch unit 53 in a configuration where the first positive-side parallel relay 57 is short-circuited to the other end of the first positive-side relay 51, the first end of the first capacitor 54, the first end of the first power-supplied object 21, and a first end of the positive side switch unit 53.

The other end of the second positive side relay 58 is electrically connected to the second positive side conductive path 34 in a configuration where the second positive-side parallel relay 58 is short-circuited to the second positive side conductive path 34. The other end of the second positive side parallel relay 52 is electrically connected to the other end of the second positive-side relay 52, the first end of the second capacitor 64, the first end of the first power-supplied object 21, and the other end of the positive side switch unit 53 in a configuration where the second positive-side parallel relay 58 is short-circuited to the other end of the second positive-side relay 52, the first end of the second capacitor 64, the first end of the first power-supplied object 21, and the other end of the positive side switch unit 53.

The positive-side resistance unit 56 is a known resistor, for example. The first positive side parallel relay 57 and the second positive-side parallel relay 58 may be configured to include a mechanical switch with contacts, or may be configured to include a semiconductor switching element, such as a field effect transistor (FET). In the on state, the first positive-side parallel relay 57 allows current to flow from the battery 20 to the first power supplied object 21 via the first positive side parallel relay 57, and in the off state, the first positive-side parallel relay 57 cuts off the flow of current from the battery 20 to the first power supplied object 21 via the first positive-side parallel relay 57. In the on state, the second positive side parallel relay 58 allows current to flow from the battery 20 to the second power-supplied object 22 via the second positive-side parallel relay 58, and in the off state, the second positive-side parallel relay 58 cuts off the flow of current from the battery 20 to the second power-supplied object 22 via the second positive side parallel relay 58.

The positive-side parallel circuit 55A performs a precharging operation to supply power to the first positive side conductive path 33 when the first positive-side relay 51 is in the off state and the first positive side parallel relay 57 is in the on state. The positive-side parallel circuit 55B performs a precharging operation to supply power to the second positive side conductive path 34 when the second positive side relay 52 is in the off state and the second positive-side parallel relay 58 is in the on state.

The vehicle power source apparatus 10 includes negative-side parallel circuits 65A and 65B. These negative side parallel circuits 65A and 65B correspond to examples of “parallel circuits” for the present disclosure.

The negative-side parallel circuit 65A is provided in parallel with the first negative-side relay 61. The negative-side parallel circuit 65A is constructed by connecting a negative side resistance unit 66 and a first negative-side parallel relay 67 in series. A first end of the negative-side parallel circuit 65A is electrically connected to the path between the first end of the first negative-side relay 61 and the negative terminal of the battery 20 in a configuration where the negative-side parallel circuit 65A is short-circuited to the path between the first end of the first negative-side relay 61 and the negative terminal of the battery 20. This first end of the negative-side parallel circuit 65A is electrically connected to the positive terminal of the battery 20, the first end of the first negative-side relay 61, and the first end of the second negative-side relay 62 in a configuration where the negative-side parallel circuit 65A is short-circuited to the positive terminal of the battery 20, the first end of the first negative-side relay 61, and the first end of the second negative-side relay 62. The other end of the negative-side parallel circuit 65A is electrically connected to the first negative-side conductive path 43 in a configuration where the negative-side parallel circuit 65A is short-circuited to the first negative-side conductive path 43. The other end of the negative side parallel circuit 65A is electrically connected to the other end of the first negative side relay 61, the other end of the first capacitor 54, the other end of the first power supplied object 21, and the first end of the negative-side switch unit 63 in a configuration where the negative-side parallel circuit 65A is short-circuited to the other end of the first negative side relay 61, the other end of the first capacitor 54, the other end of the first power-supplied object 21, and the first end of the negative-side switch unit 63.

The negative side parallel circuit 65B is provided in parallel with the second negative-side relay 62. The negative side parallel circuit 65B is configured by connecting the negative side resistance unit 66 and a second negative-side parallel relay 68 in series. A first end of the negative-side parallel circuit 65B is electrically connected to the path between the first end of the second negative-side relay 62 and the negative terminal of the battery 20 in a configuration where the negative-side parallel circuit 65B is short-circuited to the path between the first end of the second negative-side relay 62 and the negative terminal of the battery 20. The first end of the negative-side parallel circuit 65B is electrically connected to the positive terminal of the battery 20, the first end of the first negative-side relay 61, and the first end of the second negative side relay 62 in a configuration where the negative-side parallel circuit 65B is short-circuited to the positive terminal of the battery 20, the first end of the first negative side relay 61, and the first end of the second negative-side relay 62. The other end of the negative-side parallel circuit 65B is electrically connected to the second negative side conductive path 44 in a configuration where the negative-side parallel circuit 65B is short-circuited to the second negative-side conductive path 44. The other end of the negative-side parallel circuit 65B is electrically connected to the other end of the second negative-side relay 62, the other end of the second capacitor 64, the other end of the second power-supplied object 22, and the other end of the negative-side switch unit 63 in a configuration where the negative-side parallel circuit 65B is short-circuited to the other end of the second negative side relay 62, the other end of the second capacitor 64, the other end of the second power supplied object 22, and the other end of the negative-side switch unit 63.

A first end of the negative-side resistance unit 66 is electrically connected to the path between the first end of the first negative-side relay 61 and first end of the second negative-side relay 62 and the negative terminal of the battery 20 in a configuration where the negative-side resistance unit 66 is short-circuited to the path between the first end of the first negative side relay 61 and first end of the second negative side relay 62 and the negative terminal of the battery 20. The other end of the negative side resistance unit 66 is electrically connected to the first end of the first negative-side parallel relay 67 and the first end of the second negative-side parallel relay 68 in a configuration where the negative-side resistance unit 66 is short-circuited to the first end of the first negative-side parallel relay 67 and the first end of the second negative-side parallel relay 68.

The other end of the first negative side parallel relay 67 is electrically connected to the first negative side conductive path 43 in a configuration where the first negative-side parallel relay 67 is short-circuited to the first negative side conductive path 43. The other end of the first negative side parallel relay 67 is electrically connected to the other end of the first negative-side relay 61, the other end of the first capacitor 54, the other end of the first power-supplied object 21, and the first end of the negative-side switch unit 63 in a configuration where the first negative-side parallel relay 67 is short-circuited to the other end of the first negative-side relay 61, the other end of the first capacitor 54, the other end of the first power-supplied object 21, and the first end of the negative-side switch unit 63.

The other end of the second negative side parallel relay 68 is electrically connected to the second negative side conductive path 44 in a configuration where the second negative side parallel relay 68 is short circuited to the second negative-side conductive path 44. The other end of the second negative-side parallel relay 68 is electrically connected to the other end of the second negative-side relay 62, the other end of the second capacitor 64, the other end of the second power-supplied object 22, and the other end of the negative-side switch unit 63 in a configuration where the second negative side parallel relay 68 is short-circuited to the other end of the second negative side relay 62, the other end of the second capacitor 64, the other end of the second power-supplied object 22, and the other end of the negative-side switch unit 63.

The negative-side resistance unit 66 is a known resistor, for example. The first negative-side parallel relay 67 and the second negative-side parallel relay 68 may be configured to include a mechanical switch with contacts, or may be configured to include a semiconductor switching element, such as a field effect transistor (FET). In the on state, the first negative-side parallel relay 67 allows current to flow from the first power-supplied object 21 to the battery 20 via the first negative-side parallel relay 67, and in the off state, the first negative-side parallel relay 67 cuts off the flow of current from the first power supplied object 21 to the battery 20 via the first negative side parallel relay 67. In the on state, the second negative-side parallel relay 68 allows current to flow from the second power-supplied object 22 via the second negative-side parallel relay 68 to the battery 20, and in the off state, the second negative side parallel relay 68 cuts off the flow of current from the second power-supplied object 22 via the second negative-side parallel relay 68 to the battery 20.

The vehicle power source apparatus 10 includes a thermal fuse 59. The thermal fuse 59 melts when its temperature exceeds a melting temperature. The thermal fuse 59 is provided on the first negative-side branch path 41 (in more detail, on a part of the first negative side branch path 41 that is closer to the battery 20 than the first negative-side relay 61).

The vehicle power source apparatus 10 includes voltage detector units 70, 71, 72, 73, 74, and 75, a current detector unit 76, temperature detector units 77, 78, 79, and 80, and a control unit 81.

The voltage detector unit 70 detects the potential difference across both ends of the first positive side relay 51. The voltage detector 71 detects the potential difference across both ends of the second positive-side relay 52. The voltage detector 72 detects the potential difference across both ends of the first negative-side relay 61. The voltage detector unit 73 detects the potential difference across both ends of the second negative-side relay 62. The voltage detector unit 74 detects the voltage of the first capacitor 54 (in more detail, the potential difference across both ends of the first capacitor 54). The voltage detector unit 75 detects the voltage of the second capacitor 64 (in more detail, the potential difference across both ends of the second capacitor 64). The voltage detector units 70, 71, 72, 73, 74, and 75 are constructed of known voltage detector circuits, for example. The voltage detector units 70, 71, 72, 73, 74, and 75 output signals that enable detection values to be specified. The control unit 81 specifies the potential difference across both ends of each of the first positive side relay 51, the second positive side relay 52, the first negative-side relay 61, and the second negative-side relay 62 based on the signals outputted from the voltage detector units 70, 71, 72, and 73. The control unit 81 specifies the voltage of the first capacitor 54 based on a signal outputted from the voltage detector unit 74. The control unit 81 specifies the voltage of the second capacitor 64 based on a signal outputted from the voltage detector unit 75.

The current detector unit 76 detects the value of the current flowing on the negative-side common path 40. The current detector unit 76 is constructed as a known current sensor, for example. The current detector unit 76 outputs a signal that enables a detected value to be specified. The control unit 81 detects the value of the current flowing on the negative side common path 40 based on the signal outputted from the current detector unit 76.

The temperature detector unit 77 detects the temperature of the first positive-side relay 51 in the on state (in more detail, the temperature of a contact of the first positive-side relay 51). The temperature detector unit 78 detects the temperature of the second positive-side relay 52 in the on state (in more detail, the temperature of a contact of the second positive-side relay 52). The temperature detector unit 79 detects the temperature of the first negative-side relay 61 in the on state (in more detail, the temperature of a contact of the first negative-side relay 61). The temperature detector unit 80 detects the temperature of the second negative-side relay 62 in the on state (in more detail, the temperature of a contact of the second negative-side relay 62). The temperature detector units 77, 78, 79, and 80 are constructed as known temperature sensors, for example. The temperature detector units 77, 78, 79, and 80 output signals that enable the detection values to be specified. The control unit 81 specifies the respective temperatures of the first positive-side relay 51, the second positive side relay 52, the first negative-side relay 61, and the second negative-side relay 62 based on the signals outputted from the temperature detector units 77, 78, 79, and 80.

### 3. Configuration of Control Unit 81

The control unit 81 includes an integrated circuit, such as an MCU (Micro Controller Unit). The control unit 81 includes an information processing unit, such as a CPU, and a storage unit, such as ROM or RAM.

The control unit 81 controls the first positive-side relay 51, the second positive-side relay 52, the first negative-side relay 61, the second negative-side relay 62, the first positive side parallel relay 57, the second positive side parallel relay 58, the first negative-side parallel relay 67, the second negative-side parallel relay 68, the positive side switch unit 53, and the negative-side switch unit 63.

When a start condition for starting the charging or discharging of the battery 20 is satisfied, the control unit 81 executes first control for controlling the parallel relay in a parallel circuit provided in parallel with a relay to be switched out of the first positive side relay 51, the second positive-side relay 52, the first negative-side relay 61, and the second negative-side relay 62 to the on state. When a switching condition is satisfied during the execution of the first control, the control unit 81 executes second control for switching the relay to be switched to the on state.

As one example, the start condition is the vehicle switching to a startup state. As one example, the startup state of the vehicle is a startup switch being switched to an on state (as examples, an ignition switch or a power switch). As one example, the control unit 81 identifies the on/off state of the startup switch by acquiring an on/off signal indicating the on/off state of the startup switch directly or via another control apparatus.

### 3-1. Example Operation When Relay to be Switched is First Positive-Side Relay 51

When the relay to be switched is the first positive-side relay 51, the control unit 81 executes the first control as follows, for example. The control unit 81 controls the first positive side parallel relay 57 of the positive-side parallel circuit 55A, which is provided in parallel with the first positive-side relay 51, to place the first positive-side parallel relay 57 in the on state. In addition to this control, as part of the first control, the control unit 81 executes different control as follows in keeping with the object to which power is to be supplied.

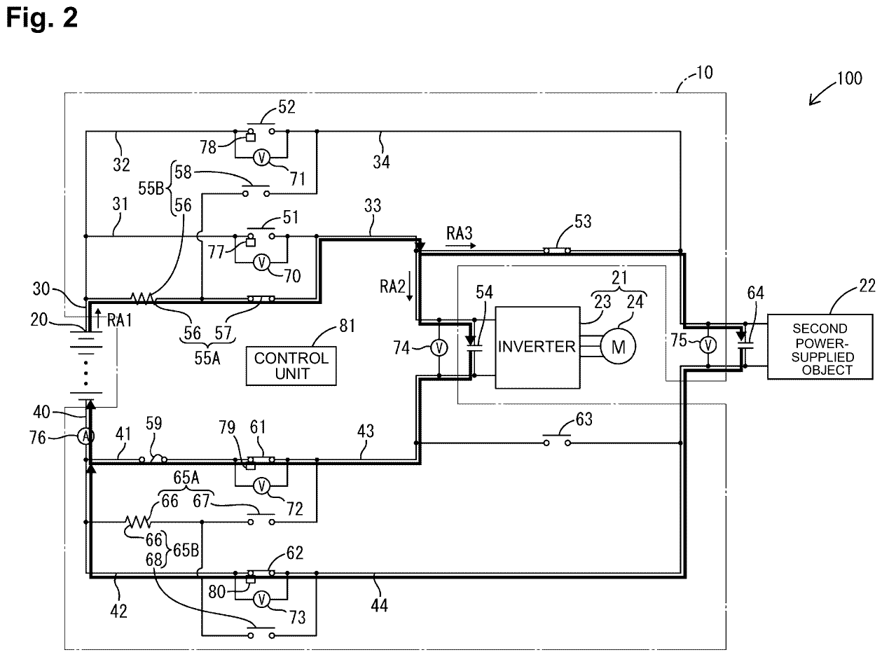

When the object to which power is to be supplied is the first power-supplied object 21, as one example, the control unit 81 performs control that places the first negative-side relay 61 in an on state. By doing so, current flows on the paths RA1 and RA2 depicted in FIG. 2, so that power is supplied from the battery 20 to the first capacitor 54. In other words, a precharge operation for charging the first capacitor 54 is performed.

When the object to which power is to be supplied is the second power-supplied object 22, as one example the control unit 81 performs control to place the positive-side switch unit 53 and the second negative-side relay 62 in the on state. By doing so, current flows on the paths RA1 and RA3 depicted in FIG. 2, so that power from the battery 20 is supplied to the second capacitor 64. In other words, a precharge operation for charging the second capacitor 64 is performed.

When the object to be supplied with power is both the first power-supplied object 21 and the second power supplied object 22, as one example the control unit 81 performs control to place the positive-side switch unit 53, the first negative-side relay 61, and the second negative-side relay 62 into the on state. By doing so, current flows on the paths RA1, RA2, and RA3 depicted in FIG. 2 so that power from the battery 20 is supplied to the first capacitor 54 and the second capacitor 64. In other words, a precharge operation for charging the first capacitor 54 and the second capacitor 64 is performed.

When the switching condition is satisfied during the execution of the first control, the control unit 81 executes the second control. In the second control, the control unit 81 switches the first positive-side relay 51 to the on state and switches the first positive-side parallel relay 57 to the off state. By doing so, a larger amount of power is supplied to the objects.

### 3-2. Example Operation When Relay to be Switched is Second Positive-Side Relay 52

When the relay to be switched is the second positive-side relay 52, the control unit 81 executes the first control as follows, for example. The control unit 81 controls the second positive side parallel relay 58 of the positive side parallel circuit 55B, which is provided in parallel with the second positive-side relay 52, to place the second positive-side parallel relay 58 in the on state. In addition to this control, as part of the first control, the control unit 81 executes different control as follows in keeping with the object to which power is to be supplied.

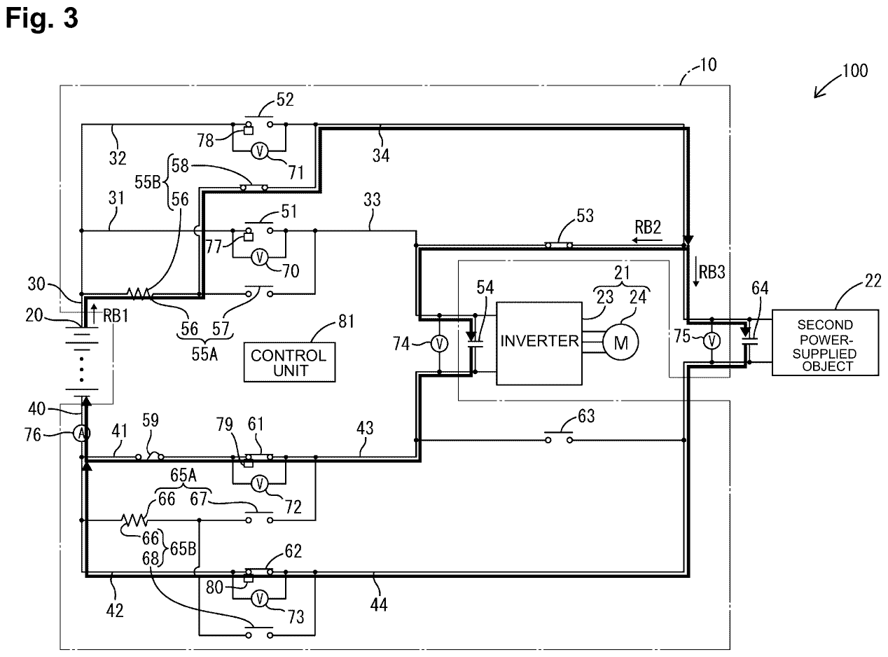

When the object to which power is to be supplied is the first power-supplied object 21, as one example, the control unit 81 performs control that places the positive-side switch unit 53 and the first negative-side relay 61 in the on state. By doing so, current flows on the paths RB1 and RB2 depicted in FIG. 3, so that power is supplied from the battery 20 to the first capacitor 54. In other words, a precharge operation for charging the first capacitor 54 is performed.

When the object to which power is to be supplied is the second power-supplied object 22, as one example the control unit 81 performs control to place the second negative-side relay 62 in the on state. By doing so, current flows on the paths RB1 and RB3 depicted in FIG. 3, so that power from the battery 20 is supplied to the second capacitor 64. In other words, a precharge operation for charging the second capacitor 64 is performed.

When the object to be supplied with power is both the first power-supplied object 21 and the second power-supplied object 22, as one example the control unit 81 performs control to place the positive side switch unit 53, the first negative-side relay 61, and the second negative side relay 62 in the on state. By doing so, current flows on the paths RB1, RB2, and RB3 depicted in FIG. 3 so that power from the battery 20 is supplied to the first capacitor 54 and the second capacitor 64. In other words, a precharge operation for charging the first capacitor 54 and the second capacitor 64 is performed.

When the switching condition is satisfied during the execution of the first control, the control unit 81 executes the second control. In the second control, the control unit 81 switches the second positive-side relay 52 to the on state and switches the second positive-side parallel relay 58 to the off state. By doing so, a larger amount of power is supplied to the objects.

3-3. Example Operation When Relay to be Switched is First Negative-side Relay 61 When the relay to be switched is the first negative-side relay 61, the control unit 81 executes the first control as follows, for example. The control unit 81 controls the first negative side parallel relay 67 of the negative-side parallel circuit 65A, which is provided in parallel with the first negative-side relay 61, to place the first negative-side parallel relay 67 in the on state. In addition to this control, as part of the first control, the control unit 81 executes different control as follows in keeping with the object to which power is to be supplied.

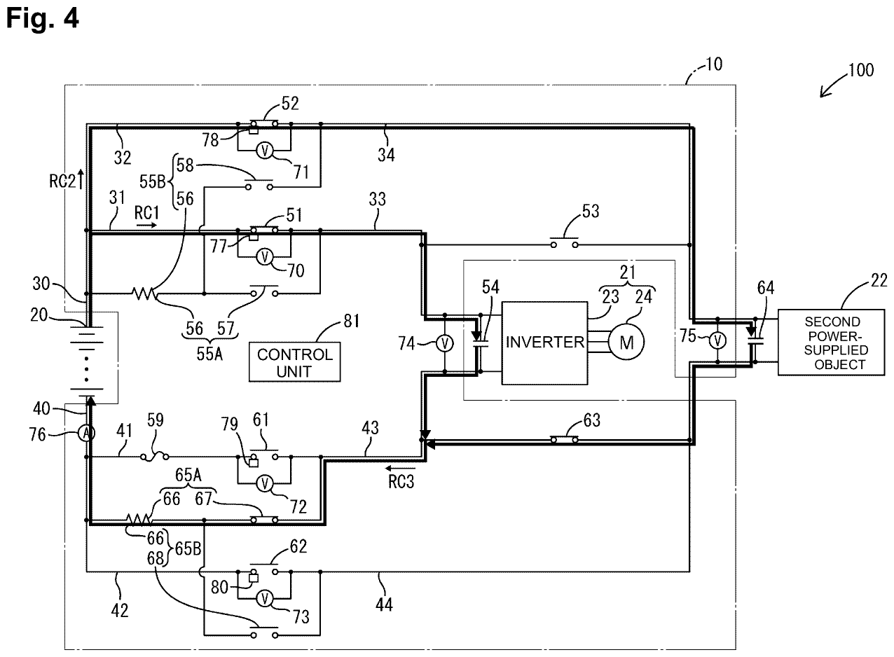

When the object to which power is to be supplied is the first power-supplied object 21, as one example, the control unit 81 perform controls that places the first positive-side relay 51 in the on state. By doing so, current flows on the paths RC1 and RC3 depicted in FIG. 4, so that power is supplied from the battery 20 to the first capacitor 54. In other words, a precharge operation for charging the first capacitor 54 is performed.

When the object to which power is to be supplied is the second power-supplied object 22, as one example the control unit 81 performs control to place the second positive-side relay 52 and the negative side switch unit 63 in the on state. By doing so, current flows on the paths RC2 and RA3 depicted in FIG. 4, so that power from the battery 20 is supplied to the second capacitor 64. In other words, a precharge operation for charging the second capacitor 64 is performed.

When the object to be supplied with power is both the first power-supplied object 21 and the second power-supplied object 22, as one example the control unit 81 performs control to place the first positive side relay 51, the second positive-side relay 52, and the negative-side switch unit 63 into the on state. By doing so, current flows on the paths RC1, RC2, and RC3 depicted in FIG. 4 so that power from the battery 20 is supplied to the first capacitor 54 and the second capacitor 64. In other words, a precharge operation for charging the first capacitor 54 and the second capacitor 64 is performed.

When the switching condition is satisfied during the execution of the first control, the control unit 81 executes the second control. In the second control, the control unit 81 switches the first negative side relay 61 to the on state and switches the first negative-side parallel relay 67 to the off state. By doing so, a larger amount of power is supplied to the objects.

### 3-4. Example Operation When Relay to be Switched is Second Negative-Side Relay 62

When the relay to be switched is the second negative-side relay 62, the control unit 81 executes the first control as follows, for example. The control unit 81 performs control to place the second negative side parallel relay 68 of the negative-side parallel circuit 65B, which is provided in parallel with the second negative-side relay 62, in the on state. In addition to this control, as part of the first control, the control unit 81 executes different control as follows, in keeping with the object to which power is to be supplied.

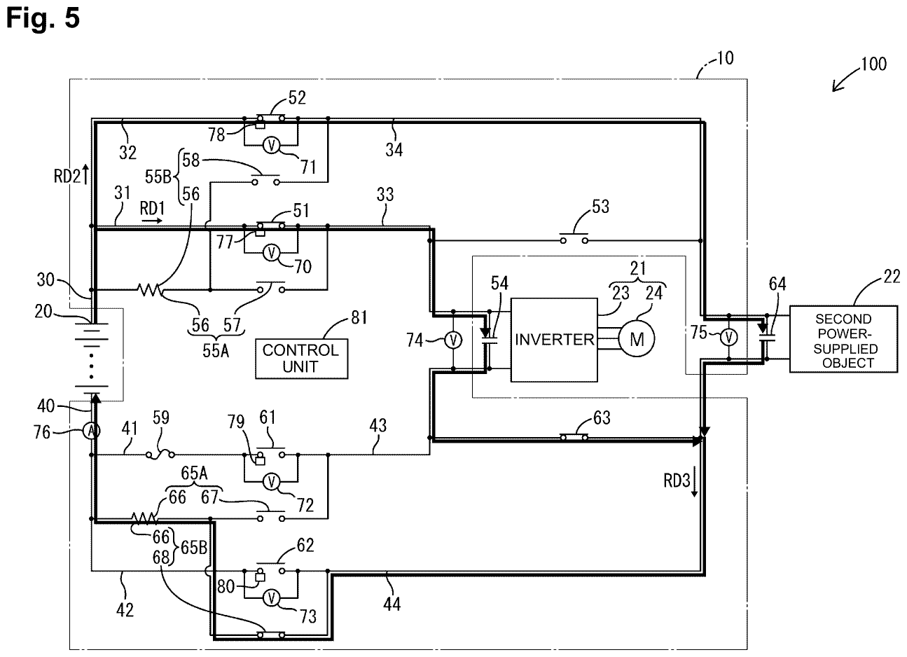

When the object to which power is to be supplied is the first power-supplied object 21, as one example, the control unit 81 performs control that places the first positive-side relay 51 and the negative-side switch unit 63 in the on state. By doing so, current flows on the paths RD1 and RD3 depicted in FIG. 5, so that power is supplied from the battery 20 to the first capacitor 54. In other words, a precharge operation for charging the first capacitor 54 is performed.

When the object to which power is to be supplied is the second power-supplied object 22, as one example the control unit 81 performs control to place the second positive-side relay 52 in the on state. By doing so, current flows on the paths RD2 and RD3 depicted in FIG. 5, so that power from the battery 20 is supplied to the second capacitor 64. In other words, a precharge operation for charging the second capacitor 64 is performed.

When the object to be supplied with power is both the first power-supplied object 21 and the second power supplied object 22, as one example the control unit 81 performs control to place the first positive-side relay 51, the second positive-side relay 52, and the negative side switch unit 63 into the on state. By doing so, current flows on the paths RD1, RD2, and RD3 depicted in FIG. 5 so that power from the battery 20 is supplied to the first capacitor 54 and the second capacitor 64. In other words, a precharge operation for charging the first capacitor 54 and the second capacitor 64 is performed.

When the switching condition is satisfied during the execution of the first control, the control unit 81 executes the second control. In the second control, the control unit 81 switches the second negative side relay 62 to the on state and switches the second negative-side parallel relay 68 to the off state. By doing so, a larger amount of power is supplied to the objects.

The switching condition mentioned above may be the potential difference across the relay to be switched being equal to or less than a predetermined value. The switching condition may be the value of the current flowing through the parallel relay (in the present embodiment, the first positive side parallel relay 57, the second positive-side parallel relay 58, the first negative-side parallel relay 67, or the second negative-side parallel relay 68) in the parallel circuit (in the present embodiment, one of the positive-side parallel circuits 55A and 55B and the negative-side parallel circuits 65A and 65B) provided in parallel with the relay to be switched being equal to or less than a predetermined value. The switching condition may be a predetermined time elapsing from the start of the first control. When the object to which power is supplied is the first power-supplied object 21, the switching condition may be the voltage of the first capacitor 54 reaching a predetermined value or higher. When the object to which power is supplied is the second power supplied object 22, the switching condition may be the voltage of the second capacitor 64 reaching a predetermined value or higher. The switching condition may also be a different condition.

### 3-5. Selection of Object to be Switched

The control unit 81 compares the deterioration levels of the first positive-side relay 51, the second positive-side relay 52, the first negative-side relay 61, and the second negative-side relay 62, and selects the relay to be switched based on the comparison result. In more detail, the control unit 81 selects the relay with the lowest deterioration level as the relay to be switched.

As examples, the deterioration level of a relay is determined based on the potential difference across both ends of the relay when the relay is in the on state, the value of the current flowing through the relay, the resistance value when the relay is in the on state, the number of times the relay has operated, the temperature when the relay is in the on state (in more detail, the temperature of a contact of the relay), or a combination of two or more of these. The deterioration level of a relay may be the above values themselves, or may be a value obtained by substituting the above values into an arithmetic formula.

The deterioration level of a relay increases as the potential difference across both ends of the relay increases. The deterioration level of a relay increases as the value of the current flowing through the relay decreases. The deterioration level of a relay increases as the resistance value of the relay in the on state increases. The deterioration level of a relay increases as the number of times the relay has operated increases. The deterioration level of a relay increases as the temperature of the relay in the on state increases, when it is assumed that the value of the current flowing through the relay is constant.

As an example method of specifying the potential difference across both ends of a relay, the control unit 81 specifies the potential difference across both ends of the relay for a relay that has been switched to the on state by the first control or the second control.

As a method of specifying the value of the current flowing through a relay, the control unit 81 specifies the value of the current flowing through the relay that has been switched to the on state by the first control or the second control, for example.

As an example method of specifying the resistance value of the relay when the relay is in the on state, the control unit 81 uses the methods described above to specify the potential difference across both ends of the relay and the value of the current flowing through the relay. The control unit 81 then determines the resistance value of the relay based on the specified potential difference and current value.

As a method for specifying the number of times a relay has operated, the control unit 81 counts the number of times each relay is switched to the on state by the second control, for example.

As a method of specifying the temperature of a relay in the on state, the control unit 81 specifies the temperature of a relay that has been switched to the on state by the first control or the second control, for example.

### 4. Example Effects

The vehicle power source apparatus 10 can supply power based on the battery 20 to the first power-supplied object 21 via the positive side common path 30 and the first positive side branch path 31 and can supply power to the second power-supplied object 22 via the positive-side common path 30 and the second positive-side branch path 32. Even if the first positive-side branch path 31 is cut off at a position closer to the battery 20 than the positive-side switch unit 53, the vehicle power source apparatus 10 can still supply power to the first power-supplied object 21 via the second positive-side branch path 32 by switching the positive-side switch unit 53 to the on state. Also, even if the second positive-side branch path 32 is cut off at a position closer to the battery 20 than the positive-side switch unit 53, the vehicle power source apparatus 10 can still supply power to the second power-supplied object 22 via the first positive side branch path 31 by switching the positive-side switch unit 53 to the on state. In other words, the vehicle power source apparatus 10 is less susceptible to the supplying of power from the battery 20 to the first power-supplied object 21 and the second power-supplied object 22 being interrupted.

Before switching the first positive side relay 51 or the second positive-side relay 52 to the on state, the vehicle power source apparatus 10 can perform a precharge operation to charge the first capacitor 54 and the second capacitor 64 using the positive-side parallel circuits 55A and 55B. By performing such countermeasure, the vehicle power source apparatus 10 can suppress an inrush current flowing through a relay, out of the first positive-side relay 51 or the second positive-side relay 52, that has switched to the on state, which in turn suppresses deterioration of the relays.

Although switching the first positive-side relay 51 or the second positive-side relay 52 to the on state after the precharge operation does suppress deterioration of the relays, some deterioration may still occur. The vehicle power source apparatus 10 can perform the precharge operation that charges the first capacitor 54 and the second capacitor 64 when a negative-side parallel relay (in more detail, the first negative side parallel relay 67 or the second negative side parallel relay 68), the positive side switch unit 53, and the negative-side switch unit 63 are in the on state and the first positive-side relay 51 or the second positive-side relay 52 is in the on state. After this precharge operation, the vehicle power source apparatus 10 performs a countermeasure of switching the first negative side relay 61 or the second negative side relay 62, which is provided in parallel with the negative-side parallel relay in the on state (in more detail, the first negative-side parallel relay 67 or the second negative-side parallel relay 68), to the on state, which makes it possible to supply power from the battery 20 to the first power-supplied object 21 and the second power supplied object 22 without passing the negative side resistance unit 66. By performing this operation, deterioration of the first positive-side relay 51 and the second positive-side relay 52 can be suppressed more effectively.

By executing the first control, the vehicle power source apparatus 10 can cause the parallel circuits (in this embodiment, the positive-side parallel circuits 55A and 55B and the negative-side parallel circuits 65A and 65B) disposed in parallel with the relay(s) to be switched to perform a precharge operation. By then executing the second control, the vehicle power source apparatus 10 switches the relay(s) to be switched to the on state. In other words, the vehicle power source apparatus 10 can select the relays to be switched to the on state following the precharge operation from the four relays, that is, the first positive-side relay 51, the second positive side relay 52, the first negative-side relay 61, and the second negative-side relay 62.

The vehicle power source apparatus 10 can reflect the deterioration levels of the relays in the selection of the relays to be switched out of the first positive-side relay 51, the second positive-side relay 52, the first negative side relay 61, and the second negative-side relay 62. The vehicle power source apparatus 10 selects the relay with the lowest deterioration level as the relay to be switched. This means that the vehicle power source apparatus 10 promotes uniform deterioration of the relays, which makes it easy to extend the life of an apparatus including relays.

The vehicle power source apparatus 10 can make shared use of the negative-side resistance unit 66 in the negative-side parallel circuit 65A, which is disposed in parallel with the first negative side relay 61, and the negative-side parallel circuit 65B, which is disposed in parallel with the second negative-side relay 62.

Even if the first negative-side branch path 41 is cut off at a position closer to the battery 20 than the negative side switch unit 63, by switching the negative-side switch unit 63 to the on state, the vehicle power source apparatus 10 can electrically connect the first power-supplied object 21 to the negative terminal of the battery 20 via the second negative-side branch path 42. Similarly, even if the second negative side branch path 42 is cut off at a position closer to the battery 20 than the negative side switch unit 63, by switching the negative-side switch unit 63 to the on state, the vehicle power source apparatus 10 can electrically connect the second power-supplied object 22 to the negative terminal of the battery 20 via the first negative-side branch path 41. In other words, in the vehicle power source apparatus 10, the supplying of power from the battery 20 to the first power-supplied object 21 and the second power-supplied object 22 is less susceptible to being interrupted.

The thermal fuse 59 is provided on a part of the first negative-side branch path 41 that is closer to the battery 20 than the negative-side switch unit 63. When the thermal fuse 59 exceeds the melting temperature, the thermal fuse 59 will melt and cut off the path where it is provided in the vehicle power source apparatus 10. Even when a path has been cut off, the vehicle power source apparatus 10 can still continue supplying power to the first power-supplied object 21 or the second power-supplied object 22 by bypassing the melted path using the second negative-side branch path 42.

### Second Embodiment

A vehicle power source apparatus 210 according to the second embodiment is mainly configured by omitting the negative-side parallel circuits 65A and 65B and the negative side switch unit 63 from the vehicle power source apparatus 10 according to the first embodiment. Note that in this second embodiment, components that are the same as those in the first embodiment have been assigned the same reference numerals and detailed description thereof is omitted.

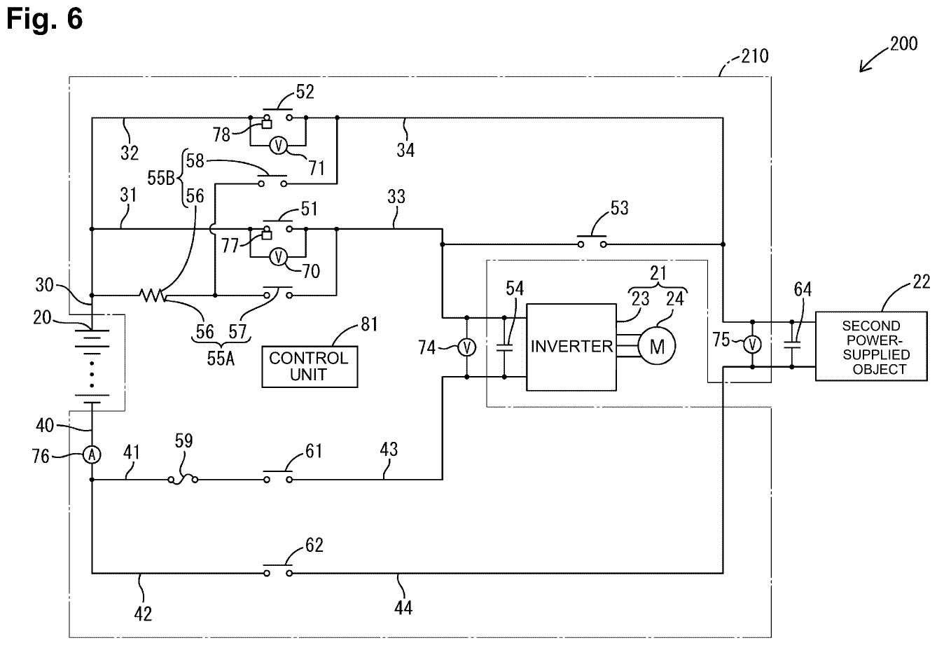

As depicted in FIG. 6, a vehicle power source system 200 including the vehicle power source apparatus 210 according to the second embodiment includes the battery 20, the first power-supplied object 21, the second power supplied object 22, the first capacitor 54, and the second capacitor 64.

The vehicle power source system 200 includes the positive-side common path 30, the first positive-side branch path 31, the second positive-side branch path 32, the negative-side common path 40, the first negative-side branch path 41, and the second negative-side branch path 42.

The vehicle power source apparatus 210 includes the first positive-side relay 51, the second positive-side relay 52, the first negative-side relay 61, the second negative side relay 62, the positive side switch unit 53, the positive-side parallel circuits 55A and 55B, and the thermal fuse 59.

The vehicle power source apparatus 210 includes the voltage detector units 70, 71, 74, and 75, the current detector unit 76, the temperature detector units 77 and 78, and the control unit 81.

When a start condition for starting the charging or discharging of the battery 20 is satisfied, the control unit 81 causes a parallel circuit (in the present embodiment, the positive-side parallel circuit 55A or the positive-side parallel circuit 55B) provided in parallel with a relay to be switched to perform a precharge operation. In the present embodiment, the relay to be switched may be the first positive-side relay 51 or the second positive side relay 52. After having the precharge operation performed, the control unit 81 executes control to switch the relay to be switched to the on state.

The control unit 81 compares the deterioration levels of the first positive-side relay 51 and the second positive side relay 52 and selects the relay to be switched based on the comparison result. The control unit 81 selects the relay with the lowest deterioration level as the relay to be switched.

The vehicle power source apparatus 210 according to the second embodiment performs a countermeasure whereby a precharge operation is performed to charge the first capacitor 54 and the second capacitor 64 using the positive-side parallel circuits 55A and 55B before the first positive-side relay 51 or the second positive-side relay 52 is switched to the on state. By using this countermeasure, the vehicle power source apparatus 210 can suppress an inrush current flowing through the relay that has been switched to the on state out of the first positive-side relay 51 and the second positive-side relay 52, which in turn suppresses deterioration of the relays.

The vehicle power source apparatus 210 can reflect the deterioration levels of the relays in the selection of the relay to be switched out of the first positive-side relay 51 and the second positive-side relay 52. The vehicle power source apparatus 210 selects the relay with the lowest deterioration level as the relay to be switched. This means that the vehicle power source apparatus 210 promotes uniform deterioration of the relays, which makes it easy to extend the life of an apparatus including relays.

### Other Embodiments

The present disclosure is not limited to the embodiments described above and depicted in the drawings. For example, the features of the embodiments described above and below may be combined in any way within a range that remains technically consistent. Any feature of the embodiments described above or below may be omitted unless clearly indicated as essential. Furthermore, the embodiments described above may be modified as follows.

Although the thermal fuse 59 is provided on the first negative side branch path 41 in the embodiments described above, the thermal fuse 59 may be provided on another path. As examples, the thermal fuse 59 may be provided on the first positive-side branch path 31, the second positive-side branch path 32, and/or the second negative-side branch path 42. Thermal fuses 59 may be provided on a plurality of paths.

Also, although the “circuit units” for the present disclosure are the positive-side parallel circuits 55A and 55B in the embodiments described above, such circuit units may use another configuration. As one example, a circuit unit may be a DC-DC converter.

Note that the embodiments disclosed above are exemplary in all respects and should not be regarded as limitations on the present disclosure. The scope of the present invention is indicated by the range of the patent claims, not the embodiments described above, and is intended to include all changes within the meaning and scope of the patent claims and their equivalents.

### LIST OF REFERENCE NUMERALS

10 Vehicle power source apparatus
20 Battery
21 First power-supplied object
22 Second power supplied object
23 Inverter
24 Motor
30 Positive-side common path
31 First positive-side branch path
32 Second positive side branch path
33 First positive-side conductive path
34 Second positive side conductive path
40 Negative-side common path
41 First negative-side branch path
42 Second negative side branch path
43 First negative-side conductive path
44 Second negative-side conductive path
51 First positive-side relay
52 Second positive-side relay
53 Positive-side switch unit
54 First capacitor
55A Positive-side parallel circuit (parallel circuit)
55B Positive-side parallel circuit (parallel circuit)
56 Positive-side resistance unit
57 First positive side parallel relay
58 Second positive-side parallel relay
59 Thermal fuse
61 First negative-side relay
62 Second negative-side relay
63 Negative-side switch unit
64 Second capacitor
65A Negative-side parallel circuit (parallel circuit)
65B Negative-side parallel circuit (parallel circuit)
66 Negative-side resistance unit
67 First negative-side parallel relay
68 Second negative side parallel relay
70 Voltage detector unit
71 Voltage detector unit
72 Voltage detector unit
73 Voltage detector unit
74 Voltage detector unit
75 Voltage detector unit
76 Current detector unit
77 Temperature detector unit
78 Temperature detector unit
79 Temperature detector unit
80 Temperature detector unit
81 Control unit
100 Vehicle power source system
200 Vehicle power source system
210 Vehicle power source apparatus
RA1 Route
RA2 Route
RA3 Route
RB1 Route
RB2 Route
RB3 Route
RC1 Route
RC2 Route
RC3 Route
RD1 Route
RD2 Route
RD3 Route

1. A vehicle power source apparatus for use in a vehicle power source system including: a battery; a positive-side common path connected to a positive terminal of the battery; a first positive-side branch path that branches from the positive-side common path; a first power-supplied object connected to the first positive-side branch path; a second positive-side branch path that branches from the positive-side common path; and a second power-supplied object connected to the second positive-side branch path,
the vehicle power source apparatus comprising:
a first positive-side relay provided on the first positive-side branch path between the battery and the first power-supplied object;
a second positive-side relay provided on the second positive-side branch path between the battery and the second power-supplied object; and
a positive-side switch unit provided between a first positive-side conductive path, which is a part of the first positive-side branch path that is closer to the first power-supplied object than the first positive-side relay, and a second positive-side conductive path, which is a part of the second positive-side branch path that is closer to the second power-supplied object than the second positive-side relay.

2. The vehicle power source apparatus according to claim 1,
wherein the vehicle power source system further includes a first capacitor that is connected to the first positive-side conductive path and a second capacitor that is connected to the second positive-side conductive path, and
the vehicle power source apparatus further comprises a circuit unit configured to perform a precharge operation that supplies power to at least one of the first capacitor and the second capacitor with the first positive-side relay and the second positive-side relay in an off state.

3. The vehicle power source apparatus according to claim 2,
wherein the vehicle power source system further includes a negative-side common path connected to a negative terminal of the battery, a first negative-side branch path that branches from the negative-side common path and is connected to the first power-supplied object, and a second negative-side branch path that branches from the negative-side common path and is connected to the second power-supplied object,
the vehicle power source apparatus further comprises:
a negative-side switch unit provided between the first negative-side branch path and the second negative-side branch path;
a first negative-side relay provided on the first negative-side branch path between the battery and the negative-side switch unit;
a second negative-side relay provided on the second negative-side branch path between the battery and the negative-side switch unit; and
a parallel circuit constructed of a resistance unit and a parallel relay that are connected in series, and
the parallel circuit is provided in parallel with each of the first negative-side relay and the second negative-side relay.

4. The vehicle power source apparatus according to claim 3,
wherein the circuit unit includes the parallel circuits provided in parallel with the first positive-side relay and the second positive-side relay respectively,
the vehicle power source apparatus further comprises a control unit configured to control the first positive-side relay, the second positive-side relay, the first negative-side relay, the second negative-side relay, and the parallel relays, and
the control unit executes, when a start condition for starting charging and discharging of the battery is satisfied, first control to control switching of the parallel relay of the parallel circuit provided in parallel with a relay to be switched out of the first positive-side relay, the second positive-side relay, the first negative-side relay, and the second negative-side relay to an on state, and executes, when a switching condition is satisfied during execution of the first control, second control to switch the relay to be switched to an on state.

5. The vehicle power source apparatus according to claim 4,
wherein the control unit compares deterioration levels of the first positive-side relay, the second positive-side relay, the first negative-side relay, and the second negative-side relay, and selects the relay to be switched based on a comparison result.

6. The vehicle power source apparatus according to claim 5,
wherein the control unit selects the relay with the lowest deterioration level as the relay to be switched.

7. The vehicle power source apparatus according to claim 3,
wherein the parallel circuit provided in parallel with the first negative-side relay has a configuration where a negative-side resistance unit as the resistance unit and a first negative-side parallel relay as the parallel relay are connected in series, and
the parallel circuit provided in parallel with the second negative-side relay has a configuration where the negative-side resistance unit and a second negative-side parallel relay as the parallel relay are connected in series.

8. The vehicle power source apparatus according to claim 1,
wherein the vehicle power source system further includes a negative-side common path connected to a negative terminal of the battery, a first negative-side branch path that branches from the negative-side common path and is connected to the first power-supplied object, and a second negative-side branch path that branches from the negative-side common path and is connected to the second power-supplied object, and
the vehicle power source apparatus further comprises a negative-side switch unit provided between the first negative-side branch path and the second negative-side branch path.

9. The vehicle power source apparatus according to claim 8,
further comprising a thermal fuse that melts when a melting temperature is exceeded,
wherein the thermal fuse is provided on at least one of: part of the first positive-side branch path that is closer to the battery than the positive-side switch unit; part of the second positive-side branch path that is closer to the battery than the positive-side switch unit; part of the first negative-side branch path that is closer to the battery than the negative-side switch unit, and part of the second negative-side branch path that is closer to the battery than the negative-side switch unit.

10. The vehicle power source apparatus according to claim 2,
further comprising a control unit configured to control the first positive-side relay, the second positive-side relay, and the circuit unit,
wherein when a start condition for starting charging and discharging of the battery is satisfied, the control unit causes the circuit unit to perform the precharge operation, and then executes control to switch a relay to be switched out of the first positive-side relay and the second positive-side relay to an on state, and
the control unit compares deterioration levels of the first positive-side relay and the second positive-side relay and selects the relay to be switched based on a comparison result.
